(19) United States
(12) Patent Application Publication
(10) Pub. No.: US 2005/0247207 A1
(43) Pub. Date: Nov. 10, 2005

(54) Drink infusion device having a submersible element & a buoyant retrieval element

(76) Inventor: Tiara Saint, Miami Beach, FL (US)

Correspondence Address: John H. Faro, Esq.;Faro & Associates, P.O. Box 4904, Key Biscayne, FL, 33149-4904, US

(21) Appl. No.: 10/838,635

(22) Filed: May 4, 2004

(51) Int. Cl. A23F 3/00

(52) U.S. Cl. 99/323

(57) ABSTRACT

A delivery system for infusion of a soluble substance from a solid incident to contact of such solid with a consumable fluid. In brief, this delivery system includes a float operatively associated with a submersible component of the delivery system. The float serves as a handle of sorts for orientation and placement of the submersible element within a brewing fluid and withdrawal of the submersible element from the fluid upon completion of the brewing cycle. In the one of the preferred embodiments of this delivery system, the delivery system is composed of a tubular member associated with a float. In another of the preferred embodiments of this invention, the submersible component is of a clam shell-like configuration, and thus capable of having a submersible element and a buoyant retrieval element.

### BACKGROUND OF THE INVENTION

1. Field of the Invention

This invention relates to an article of manufacture and to a method. More specifically, this invention relates to a device that can be used either alone, or in association with a consumable substance, in solid form, for preparation of a beverage. In one of the preferred embodiment of this invention, the device comprises a delivery system, of composite construction, suitable for use in the infusion of an extractable/soluble substance into a liquid. This delivery system can be used in the preparation of a beverage from tea leaves, naturally occurring herbs or beans and dietary supplements; the addition of a flavor enhancing substance to a beverage (e.g. natural sweeteners); the controlled release of a soluble substance into a liquid for purification/removal of toxins or pathogens from within the liquid (e.g. ozone generator); and/or for neutralization of a substance present within a liquid (e.g. pH buffer to alter relative acidity level).

2. Background of Invention

In the preparation of beverages, such as tea or coffee, loose tea leaves or coffee grounds can be initially steeped in hot water and, thereafter, separated for the resulting brew; or, alternatively, the hot water passed through a bag or filter medium containing the loose tea leaves or coffee grounds and collected in a separate vessel. More specifically, a sealed bag/envelope comprising a porous filter medium, which is initially filled with the tea leaves or coffee grounds, can be directly immersed within the vessel (e.g. cup or carafe) containing the hot water, or, alternatively, such sealed bag/envelope placed within a brewing basket and hot water passed through the basket, a transient fluid saturate the leaves and grounds, extract a soluble beverage component into such fluid from the tea leaves or coffee grounds and, thereafter, the fluid collect or flow into a cup or carafe. Alternatives to the foregoing brewing system are well-know, and have been previously disclosed both in the technical and patent literature.

The following patents are illustrative of alternative brewing baskets purportedly having one or more enhancements to the conventional means traditionally used in the preparation of a consumable liquid (e.g. beverage). In each of these alternatives one or more components of the beverage are extracted from a solid material upon contact with a fluid, such as water or preferably hot water.

U.S. Pat. No. 6,692,780 (to Sandin, issued Feb. 17, 2004) discloses a beverage infusion device comprising a brewing basket, a beverage container, means for retaining the brewing basket in the bottom of a beverage container and a compression assembly for expressing steeping fluid from the brewing basket within the beverage container. In the Sandin invention, a porous envelope is placed within the brewing basket, and the basket positioned/forced into the bottom of the beverage container past a retaining notch located in the side-wall of the container just above the bottom of the container. Thus, upon addition of steeping fluid, the basket and its contents, which are apparently buoyant, are retained within the bottom of the beverage container and seeping fluid allowed to infused/penetrated therein. After a suitable brewing interval, a press comprising a ram and plunger are inserted into the beverage container, and the ram forced to the bottom of the container compressing the contents of the brewing basket, and expressing brew from within the brewing basket into the beverage container. The brewing basket is retained in the bottom of the container upon completion of the brewing cycle, and, the brew can be consumed directly from the container or decanted into another vessel prior to consumption.

U.S. Pat. No. 6,431,056 (to Fristshi, issued Aug. 13, 2002) discloses a device for brewing beverages which includes a mechanical-hydraulic means for automatically and adjustably ending a brewing cycle. In brief, this device includes a buoyant brewing basket, which can be introduced into the brewing vessel or receptacle. In order to retain the brewing basket in place, a weighing down element engages the buoyant brewing basket to maintain it at the bottom of the brewing vessel, where it is immersed with a brewing fluid. Upon completion of the brewing cycle, the weighing down element is disengaged from the buoyant brewing basket, which can then be withdrawn from the brewing vessel.

In the typical situation where an individual cup of tea or coffee is to be prepared from loose tea leaves or coffee grounds, the separation of the tea leaves and coffee grounds from the brew must be accomplished prior to consumption. This can be readily accomplished, in the case of tea leaves, by the placement of the loose tea leaves, in a brewing basket, and immersion of the basket with the hot water. Alternatively, the loose tea leaves or coffee grounds can be pre-packaged within a porous, brewing envelope, and the brewing envelope immersed within the hot water. In each instance, the brewing envelope is permitted to remain steeping in the hot water until the desired beverage strength has been achieved.

Where the pre-package porous envelope is used to contain the tea leaves or coffee grounds, the envelope must have fairly fine porosity to retain the contents thereof within the brewing envelope. Because of its fine porosity, the brewing envelope is naturally buoyant. Accordingly, in order to effectively steep the contents of the brewing envelope within the hot water, the contents of the envelope must first be saturated with the steeping fluid before it can be remain submerged within the steeping fluid. Typically, this involves pushing the brewing envelope into the steeping fluid manually with a spoon or other comparable device, until the requisite saturation of the contents of envelope has occurred.

An alternative means for accomplishing a similar objective is disclosed in U.S. Pat. No. 5,620,720 (to Adler, issued Apr. 15, 1997). The Adler '720 patent discloses a pre-packaged beverage concentrate, in the form of a shredded, granular, powder or other solid form, within a porous envelope. In one of the embodiments of the Adler invention, the envelope is integrated within the interior side-wall of a disposable cup. Subsequent to the addition of liquid to the cup, a protective shield is removed from within the cup, thereby exposing the porous envelope to the steeping fluid. A rigid elongated pull tab assembly attached to the brewing envelope, and thereby maintains the porous envelope immersed within the steeping fluid. Upon completion of the brewing cycling, the pull tab assembly is withdrawn, along with the brewing envelope, into a compartment formed within the side-wall in the interior of the disposable cup. As the pull tab is progressively withdrawn from the cup, the brewing envelope is forced into the compartment and compressed, thereby expressing any brew that is present therein. The beverage can thereafter be consumed directly from the same cup as is used in the preparation of the or the beverage transferred to another vessel prior to its consumption.

As is evident from the foregoing, the available contrivances available for effectively brewing a beverage all involve the extraction of a soluble substance from the contents of a brewing envelope or basket. This process generally requires at least three (3) steps for an effective extraction/brewing of the contents such envelope or basket. Initially, such process requires that that the contents of the contents of a brewing envelope or basket maintain the brewing envelope submerged within the consumable fluid to permit saturation of the contents of the contents of a brewing envelope or basket with fluid for an interval sufficient to permit extraction of a substance from the contents of the envelope; the diffusion of an extracted substance from within the envelope/basket into the surrounding fluid; and, subsequent removal or isolation of the brewing envelope/basket from the fluid to arrest continued extraction of substances from within the brewing envelope or basket into the fluid.

As is evident from the foregoing, the initial saturation of the brewing envelope (and its contents), and the maintenance thereof immersed within the fluid within a brewing vessel filled with fluid is a common objective and problem encountered in each of the more complex and simplistic brewing regimes discussed above. Similarly, the removal of the brewing envelope from the steeped fluid also presents a concern in some environments because it generally results in a not insubstantial loss of fluid from the brewing vessel.

The contrivance described by Adler approaches these common objectives and problems by anchoring the brewing envelope below the level of the fluid within the vessel and, thereafter, isolation (at least partially) from the fluid upon completion of the brewing cycle, within the same vessel. The withdrawal of the brewing envelope into the pocket in of brewing vessel compresses the envelope thereby express brew from the envelope into the vessel and thereby conserving the amount of brew. While this approach eliminates the need to separately dispose of the brewing envelope, it does not accommodate the needs of the consumer to control over the strength or flavor of the resulting brew, because of the retention of the brewing envelope within the same container contemplated for consumption of the brew.

Accordingly, there continues to exist a need to improve the preparation of a brewed beverage from an envelope containing a soluble or extractable substance (tea or coffee) wherein the contents of the envelope are easily immersed within a fluid and retained in place without additional mechanical force or elaborate modification to the brewing vessel or/brewing basket. In addition, improvement is also needed in the means or methods used to remove to the remove the brewing envelope from the fluid so as to minimize the removal and loss of fluid from the brewing vessel.

### OBJECTS OF THE INVENTION

It is the object of this invention to remedy the above as well as related deficiencies in the prior art.

More specifically, it is the principle object of this invention to provide a simple yet effective means for both infusion of a substance, from an herb or flavoring or medicinal, into a consumable fluid, and the subsequent retrieval of the substance, to the extent not dissolved within the consumable fluid, upon completion of the infusion cycle.

It is another object of this invention to provide a composite device, and brewing system, which includes a float and a relatively non-buoyant carrier, for both infusion of a substance, from an herb or flavoring or medicinal associated with the non-buoyant carrier, into a fluid by immersion thereof into a consumable fluid, and the subsequent retrieval of the non-buoyant carrier by means of the float, from the consumable fluid, upon completion of the infusion cycle.

It is yet another object of this invention to provide a composite device which includes a float and a relatively non-buoyant carrier, wherein the non-buoyant carrier includes a brewing basket.

It is yet another object of this invention to provide a composite device which includes a float and a relatively non-buoyant carrier, wherein the non-buoyant carrier is at least partially soluble within a consumable fluid.

It is still yet another object of this invention to provide a composite device which includes a float and a relatively non-buoyant carrier, wherein the float is formed of a material that is symbolic, as to product identification or the source of the product.

Additional objects of this invention include a method for infusion of a substance into a consumable fluid, and the retrieval of a carrier of such substance from such fluid.

### SUMMARY OF THE INVENTION

The above and related objects are achieved by providing a delivery system for infusion of a substance, originally in solid form, or which is encapsulated within a capsule, (that is itself soluble), into a consumable fluid Within the context of this invention, the delivery system has two primary functional components, (a) a buoyant component or a float and (b) a relatively non-buoyant or submersible component, for example, a component that has is heavier (denser) than the consumable fluid within which it is intended to be submerged. The float is affixed to the submersible component so as to allow for both the orientation and immersion of the submersible component within the consumable fluid; and, thereafter, for the subsequent retrieval of the submersible component from such fluid, upon the completion of the infusion (e.g. brewing) cycle.

In one of the preferred embodiments of this invention, the delivery system of this invention comprises a tubular member or straw having an upper segment associated with a buoyant component or a float and a lower or submersible component that is associated (e.g. coated. Impregnated, etc.) with a soluble substance that dissolves within a consumable liquid. The upper segment of the tube or straw is preferable modified along its length to provide/allow from axial movement of the a buoyant component or a float, along a portion of the length of the upper segment, as the level of the consumable liquid drops during the consumption thereof. This modification can take the form of “stops” that are added to or molded into the side-wall of the tube/straw which limit the axial movement of the float within the portion of the upper segment of the tube/straw defined by these stops.

In another of the preferred embodiments of this invention, the delivery system of this invention is suitable for brewing a beverage, such as tea or coffee. In this preferred delivery system of the invention, the loose tea leaves or coffee grounds are pre-measured and sealed within an envelope (e.g. tea bag or coffee pouch), and confined within the non-buoyant component of the delivery system, which can be in the form of a “clam shell” or comparable structure. This clam shell can be affixed on one end thereof to a float which rides on the surface of the consumable fluid while maintaining the relatively buoyant clam shell, and its contents, oriented in a vertical position, relative to the surface of the fluid contents of the brewing vessel, and, thus, submerged within the consumable fluid. The contents of the pre-measured envelope are, thus, steeped in consumable fluid, and an extract from the enveloped infused into the fluid thereby forming a “brew”. Once this brew has been formed, in the desired strength (concentration), the float is raised from the surface of the consumable fluid, the clam shell extracted from the consumable fluid. In this preferred embodiment of the invention, the clam shell containment of the pre-measured envelope, exerts sufficient pressure upon the contents of the envelope to inhibit absorption of substantial quantities of consumable fluid, and thereby does not substantially deplete/reduce the volume of consumable fluid upon its extraction/removal from such fluid. In order to achieve comparable brewing efficiency, the float can be used to agitate the clam shell within the consumable fluid to enhance the exchange of fluid relative to the envelope.

The float component of this delivery system can include alpha numeric information or designs which impart information relative to the substances to be used in conjunction therewith (e.g. type of tea, or relative amount of caffeine, etc.), or simply an advertiser's message. Alternatively, the surface of the float can be used to write on, for example, to identify an individual or the nature of the substance that is being infused into the consumable fluid. Thus, for example, where the substance being infused into the consumable fluid is a medicinal agent, the float can identify the substance, the dosage form and/or its relative potency.

### BRIEF DESCRIPTION OF DRAWINGS

FIG. 1 is perspective view of the preferred embodiment of the delivery system of this invention within a container of consumable fluid.

FIG. 2A is an isolated view of the delivery system of this invention wherein the submergible (non-buoyant) component is in the form of “clam shell-like” assembly.

FIG. 2B is an alternative embodiment of the delivery system of FIG. 2A, wherein each component of the clam shell is assembled from individual components.

FIG. 3A is an alternative embodiment of this invention in the form of a tubular device or straw.

FIG. 3B is an exploded view of one of the alternative embodiments of this invention depicted in FIG. 3A.

### DESCRIPTION OF THE INVENTION INCLUDING PREFERRED EMBODIMENTS

The Figures which accompany this application, and referenced herein, depict representative delivery system of this invention. In the embodiments of this invention illustrated in these Figures, the components of the delivery system have been isolated from one another, where practical, to depict their individual features and interactions of such features with one another. To the extent practical, elements appearing in each of the foregoing Figures which are common to more than one Figure are assigned a common reference numeral for each of understanding and economy of expression.

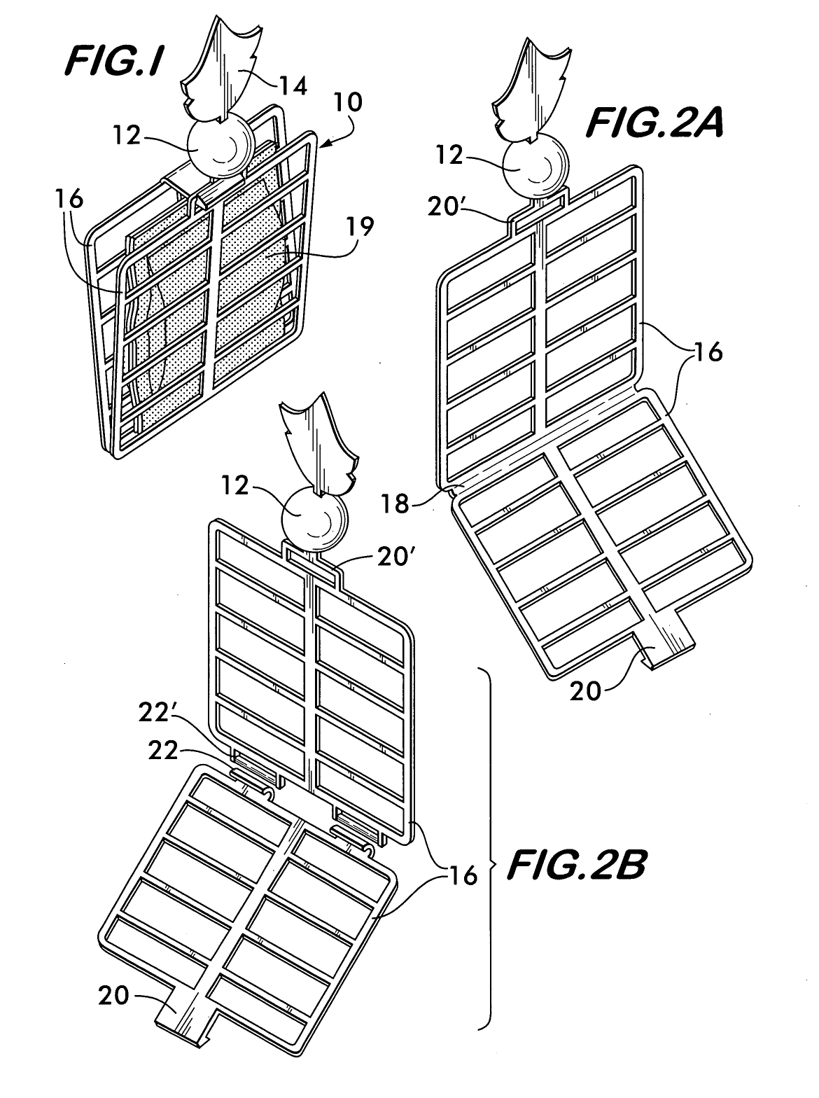

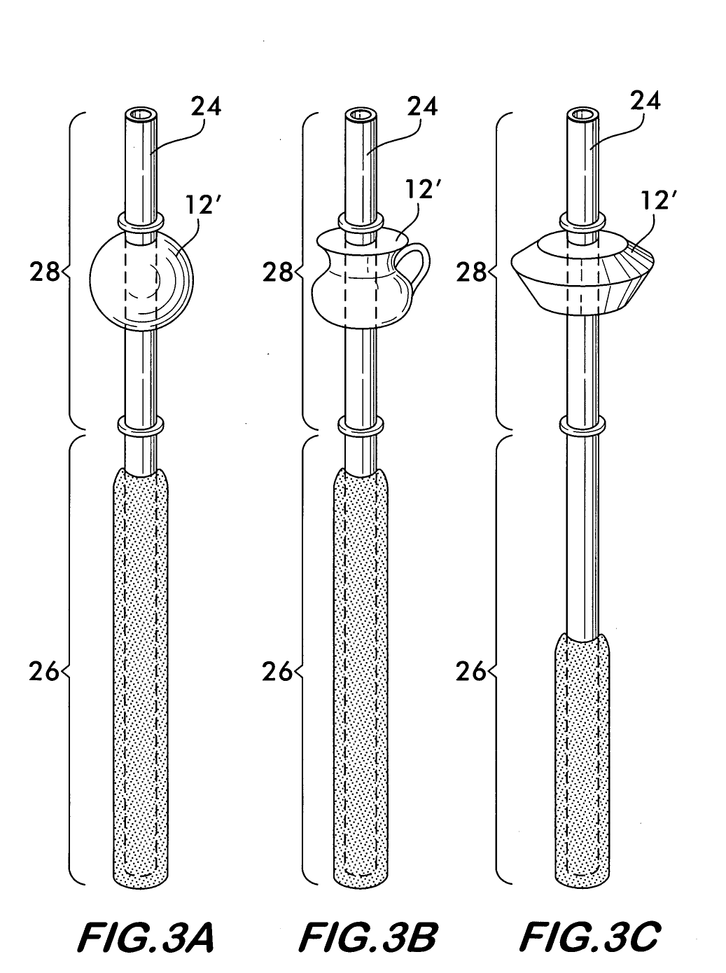

FIG. 1 depicts a preferred embodiment of this invention within the context of preparation of a cup of tea. The delivery system (10) shown in this FIGS. 1 & 2, includes a float (12), having depicted thereon a promotional message/symbol of a tea bag supplier, a stem or tab (14) which joins the float (12) to a fluid permeable basket (16) in the form of a clam shell (FIG. 2). This basket (16) is preferable fashioned from a compliant plastic webbing that is designed to both retain a brewing envelope (18) and yet permit fluid to freely flow around and into the brewing envelope. The terms “compliant” and “plastic” are used in the characterization of this webbing to both connote the function of a compliant material as forgiving shape, and yet one that impart a compressive force on the envelope placed therein, to both insure retention by the webbing and yet provide for minimal absorption of consumable fluid into the brewing basket upon its withdrawal from the brewing environment of the cup or container.

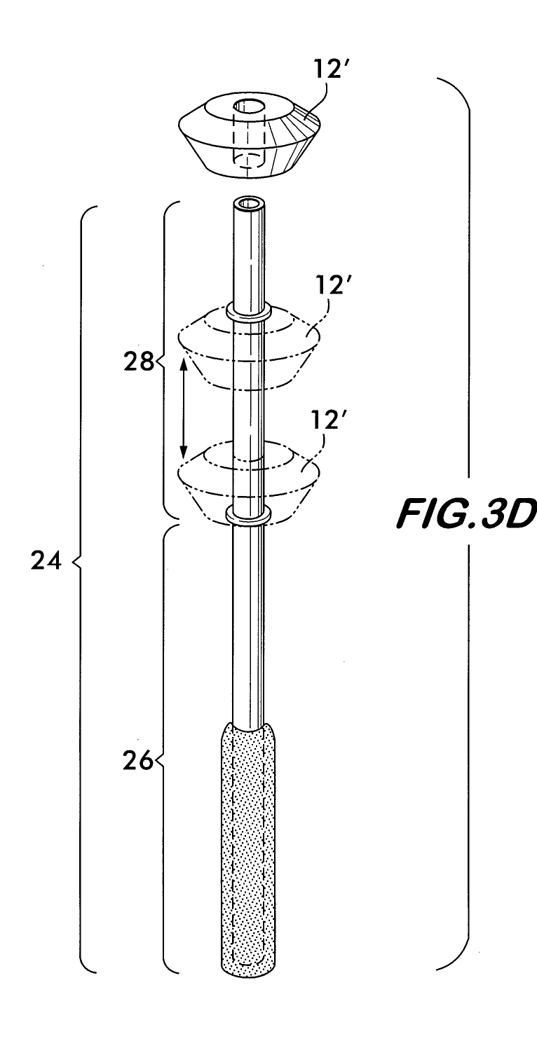

As is evident from FIGS. 1 & 2, this fluid permeable basket (16) can have a single unitary structure wherein each have thereof is connected to one another, on one border, by a living hinge (FIG. 2A, 18); and, on the opposing border, by a releasable mechanically coupling (20, 20′). Thus, when the mechanical coupling (20, 20′) is disengaged (e.g. clasp) on the open end of the basket a solid substance/or envelope containing a solid substance, for example, a tea bag can be placed within the confines thereof, and the basket closed by engagement of each of the complementary members of the mechanically coupling (20, 20′) on the open end thereof. Alternatively, this fluid permeable basket (14) can have two interlocking components, as illustrated in FIG. 3B, wherein each component is mated with the other by compression fittings (22, 22′) located along the common opposing borders of each. Within the context of this invention, alternatives 2A and 2B are considered interchangeable and functionally equivalent. Thus, after the brewing cycle is completed the fluid permeable basket (16) is opened by releases of the clasp (20, 20′) or compression fittings (22, 22′), as the case may be.

The size and shape of the fluid permeable basket (16) can be configured for a particular shaped container, or as shown in FIGS. 1 & 2, or simply have a universal size and shape compatible with a variety of brewing environments, such as a tea or coffee cup/mug.

In another of the preferred embodiments of this invention, as shown in FIG. 3, the delivery system of this invention can include a float (12) that is associated, in captive relation, with a drinking straw (24). The lower portion of the straw (26) is, as in the embodiment of this invention, shown and described above, coated with a. flavoring material, such as Cool-Aid, which is coated, in solid form, upon the submersible segment/end (26) of the straw. Thus, upon immersion of the submersible segment/end of straw into a consumable liquid (e.g. water), the flavoring is dissolved and a consumable beverage prepared. The top/upper portion (28) of the straw is maintained above the fluid level in the container by means of the float (12) associated therewith and, thus, is always accessible to the consumer. More specifically, as the beverage within the container is consumed, and the fluid level drops, the height of the straw within the container will automatically accommodate the fluid level, without loss of accessibility to the consumer. Thus, in beverage containers of the magnitude of the 7-11 convenience store, “Big Gulp” (32 to 64 ounces), the consumer end of straw remains afloat, and progressively adjusts to the level of the remaining beverage in the container, as the beverage is progressively consumed.

The basic design of the delivery system of this invention can be further enhanced by, for example, the addition/incorporation of novelty items into the float; by addition of advertising graphics or corporate logos to the float; by provision of a surface to the float that can be used to imprint customer or user identification; by etc.,

Other modification and enhancements to the foregoing delivery system, consistent with its intended usage, are thus also within the contemplation and spirit of this invention. The foregoing description and accompanying drawing are, thus, intended as simply illustrative of a number of preferred embodiments of this invention, and not otherwise intended as delineating its scope, which is set forth in the claims that follow.

1. In a delivery system for infusion of a soluble component, in a solid form, from a submersible insoluble carrier, into a consumable fluid by immersion of said carrier into said consumable fluid, wherein said solid is, at least initially, adsorbed upon or contained within said submersible carrier, and the carrier physically attached or tethered to means for placement and subsequent withdrawal of the submersible carrier from a consumable fluid, wherein the improvement comprising:
an infusion device having essentially two discrete segments, a buoyant segment and a submersible segment,
said buoyant segment including a float associated therewith that is either fixedly positioned along said buoyant segment or slidingly moveable along said segment within a defined range of movement,
said submersible segment being either continuous with or coupled to said buoyant segment at one end thereof, and the other end thereof being adapted to provide carrier means for a dissolvable or extractable substance, wherein said dissolvable or extractable substance is soluble in a consumable fluid.

2. The delivery system of claim 1, wherein the infusion device comprises a tubular or drinking straw-like member having a soluble material absorbed on the submersible end thereof.

3. The delivery system of claim 1, wherein the infusion device comprises a solid rigid rod having a soluble material absorbed on the submersible end thereof.

4. The delivery system of claim 1, wherein the infusion device comprises a buoyant float and a submersible brewing basket for containment of an herbal or natural substance.

5. In a delivery system for infusion of a soluble component of a solid from an insoluble carrier into a consumable fluid, wherein said solid is, at least initially, contained within a porous envelope or soluble capsule, and the said envelope or capsule physically attached or tethered to means for placement of the solid into a consumable fluid and removal of said solid from said consumable fluid, wherein the improvement comprising:
(a) a submersible ensemble for engaging a porous envelope or soluble capsule, said submersible ensemble having means for coupling to a line or tether and composed of essentially non-buoyant materials;
(b) a float comprising a buoyant body and means for coupling to a line or tether; and
(c) a line or tether affixed to each of said submersible ensemble, with the proviso that said line or tether can be either distinct from each of said of said submersible ensemble or float, integral with either said submersible ensemble or float or integral with each of said submersible ensemble and float.

2. The delivery system of claim 5, wherein said porous envelope is tea bag.

3. The delivery system of claim 5, wherein said submersible ensemble is a brewing basket.

5. The delivery system of claim 5, wherein said buoyant body float selected the group consisting of a symbol, alpha numeric information, color code indicia and any combination thereof, indicative of information which either identifies a sponsor, manufacturer or a solid material associated with said submersible component of said infusion device
